(19) United States
(12) Patent Application Publication
(10) Pub. No.: US 2009/0291191 A1
(43) Pub. Date: Nov. 26, 2009

(54) Processed Potato Product

(76) Inventor: Gary Brian Leech, New South Wales (AU)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 11/917,428

(22) PCT Filed: Jun. 7, 2006
(86) PCT No.: PCT/AU06/00784

§ 371 Date: Dec. 13, 2007

(30) Foreign Application Priority Data
Jun. 14, 2005 (AU) 200593096

(51) Int. Cl. A23L 1/216; A23L 1/01

(52) U.S. Cl. 426/637; 426/438

(57) ABSTRACT

A ready to eat potato product having less than 20% fat prepared by frying dehydrated whole potato pieces having between 6.0 and 8.5% moisture to expand the starch in the potato pieces.

### FIELD OF THE INVENTION

The invention relates to a process for manufacturing a low fat, ready to eat potato product from dehydrated potato pieces. In particular it relates to a novel process for making low fat potato chips and the product of the process.

### BACKGROUND OF THE INVENTION

In this specification where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

While the following invention will be described with reference to potato based snack foods the invention is not so limited but applies to other “ready-to-eat” potato products including potato “croutons” for addition to soups and salads.

Snack foods form a large proportion of sales in the Australian food industry, and potato chips are one of the most popular of all snack foods. This pattern is repeated throughout Europe and North America. Australia's population of 20 million people currently spends AUD$1 billion per year buying potato chips.

### Potato History

Potatoes have been part of European cooking for centuries. During the late 1400s and early 1500s, the Spanish Conquistadors, brought back potatoes from the Andes mountains of South America. Potatoes were introduced to mainstream Continental European cuisine by Parmentier, the horticulturist to French King Louis XIV. The first (English) settlers to bring the potato to Australia and the United States regarded it primarily as animal fodder and it was not until large numbers of German and northern European migrants began to arrive that the potato became the human food item it is today.

### Types of Potatoes

On a world basis, potatoes are only second to rice in human consumption. There are many different types of potato produced. Apart from appearance, the principal difference between the varieties is the water content, and the amount and nature of starch each contains.

Potatoes good for baking, mashing and frying have relatively high levels of starch. This starch is of the type known as amylose starch. These include the varieties known as Russet Burbank, Russet Arcadia, Norgold Russet, Goldrush, Norkotah, Long White, Atlantic and Idaho. They tend to be long and have a coarse, cork-like skin and internally, a dry, mealy texture. But, they turn light and fluffy when cooked. These types of potatoes are a staple for the food processing industry which uses them for manufacture of products including oven chips and potato chips.

Potatoes good for boiling, roasting, barbecuing and potato salad are high in moisture and sugar, but low in starch. The starch is of the type known as amylopectin. These include the varieties known as White (Sebago, Coliban), Round Red, Yellow Potato, Red Potato, Red Pontiac, Red Nordland, Red Bliss, Yellow Finnish, Ruby Crescent and Australian Crescent. They come in a variety of shapes and can be long or round. They have a thin, smooth skin and an almost waxy flesh but hold their shape when cooked. These types of potatoes are a staple of the fresh food industry and Australians eat more potatoes than any other vegetable.

Some potatoes are considered to fall in the “all-purpose” category, such as the Yukon Gold, Peruvian Blue, Superior, Kennebec, and Katahdin. They are moister than baking potatoes and will hold together in boiling water. They are particularly well-suited to roasting, pan frying, and using in soups, stews, and gratins. They can be baked, mashed, and fried, but will not produce the same results as baking potatoes. These varieties are mostly used by the fresh food industry.

### Production of Potatoes

Potato farmers work with various constraints on production. The food processing industry require potatoes to fall within certain size and shape specifications to be suitable for handling by processing machinery. Farmers can control their planting practices to produce the desired size and shape but this means reduced yield. For example, Atlantic potatoes have a theoretical maximum yield of about 30 ton/acre, however in order to meet the specifications of the processing industry, they must reduce planting to a yield of about 18 ton/acre.

Potatoes that are out of specification because they are too big, too small or the wrong shape are waste. They are typically disposed of as cattle food, or dumped in paddocks, the latter potentially leading to spread of horticultural diseases. Storage of such potatoes for replanting at a later date is not practical. Potatoes need careful storage at low temperatures and then warming prior to handling and these storage requirements are not practical for most farmers.

In Australia some of the out of specification potatoes and off-cuts from oven chip production are crushed and dehydrated to form powder, granules or flakes. Dehydrated whole potato pieces have been used for many generations because potatoes keep well in this form for up to about 2 years. However they are always re-hydrated prior to consumption. Dehydrated forms of potato are used as additives to processed foods such as canned goods (such as soups and stews) or packaged good such as “instant” soups or “instant” mashed potato.

Dehydrated whole potato pieces are typically produced by the steps of:
cutting up whole potatoes into pieces,
blanching the potato pieces in hot water or steam to gelatinize starch in the potato pieces,
cooling the blanched pieces using air or cold water,
air dehydrating the blanched pieces until the desired moisture content is reached, and
packaging.

The length of time taken for the blanching process will depend on the dimensions of the piece. When the dehydrated potato pieces are slices, the thicker the slice or the larger the piece the longer the blanching process. For example a slice of 0.17 mm thickness would take about 1.5 mins to blanch while a 12 mm³ cube would typically take about 3.5 mins to blanche in a commercial blancher.

There is currently no large scale commercial production in Australia of dehydrated potato in other forms such as cubes or sticks or slices. In some other countries such as China and the USA, there is some limited production of dehydrated cubes and slices for addition to soups and casseroles.

### Potato Chips

Mass production of the “potato chip” is believed to have started in the US in 1853, when chef George Crum at the Moon Lake Lodge in Saratoga Springs, New York, reportedly sliced potatoes into extremely thin slices, wrapped them in a napkin and dropped them into a tub of ice water, waited half an hour, dumped the slices into hot grease and salted them. Reputedly he did this in retaliation when a patron complained about a meal Crum had cooked and returned it to the kitchen. Instead of complaining further, the patron loved the potatoes and asked for more. Originally Crum called the item “potato crunches.”

Initially consumed in restaurants, about 1895 several people seemed to come up with the idea of making them as a food item for sale in grocery stores. The potato chip did not leave the United States as a food item until 1921 when they were introduced in England. Since the words “chips” was already in use for what Americans call “french fries”, the word “crisps” became common in the UK. In Australia the words “crisps” and “chips” are used interchangeably.

Modern commercial production of potato chips is usually carried out in a continuous frying process or batch frying process. The latter tends to create potato chips having hardbite texture and are often referred to as ‘kettle’ chips because they are produced in an apparatus comprising fry kettle full of cooking oil.

Typically the process for producing continuously fried potato chips is a fully enclosed process that involves the steps of:
washing and peeling to remove the potato skins,
slicing the potatoes very thinly at a continuous set rate by passing the potatoes through a revolving slicer that has 8 cutting blades that are set by a gauge,
rotating the thick slices in a rotating mesh drum that is constantly running in water in order to remove most of the starch,
drying prior to entering the frying vessel,
frying in cottonseed or vegetable oil at a temperature of about 180° C. for 6 to 8 minutes, paddle wheels moving the slices forward to the front of the machine,
finishing the cooking by using a mesh screen to submerging chips in the cooking oil, and
removing the chips from the oil such that they fall onto a small mesh stainless steel conveyor and applying salt or other seasoning flavours.

The continuous process is used to manufacture products such as ‘Thins’.

By contrast, the process for batch production of potato chips is ‘open’ and typically involves the steps of:
washing and peeling to remove the potato skins,
slicing the potatoes by passing the potatoes through a revolving slicer that has 8 cutting blades that are set by a gauge,
feeding batches of slices directly into a cooking vessel, one batch at a time,
cooking at 150° C. with stirring for 7 mins, and
removing the cooked slices using a transfer conveyor located at one end of the cooking vessel.

The batch process is used to manufacture products such as ‘Kettle’ chips.

These processes are widely used. However during the frying process the slices of potato absorb a large amount of oil, providing potato chips that are up to about 25 to 38% fat. the lower (25%) level of oil absorption is achieved by pre-treating the potato slices prior to cooking to retard oil uptake. These levels are highly undesirable in the light of current efforts to reduce the health risks posed by obesity and high levels of cholesterol in blood.

Another process for potato chip manufacture was established. by Procter & Gamble who decided to take the technology for producing soap and apply it to potato chips. This product is referred to as a ‘reconstituted’ product, perhaps the most popular product being sold under the trade mark “Pringles”. The process consists of creating a slurry of potato powder, corn meal and water then pressing the slurry and frying it. Reconstituted products adsorb a large amount of oil during frying—up to about 40 wt % of the end product. In 1996 Procter & Gamble launched Fat Free Pringles made with Olean, a fat that cannot be absorbed by the body. However this product has not had widespread acceptance, possibly due to the fact that Olean causes diahorea when consumed in large quantities.

During 2002 the s'OK Real Potato Chip Company Pty, set up by Freer Foods Ltd launched a new potato chip product manufactured by a sophisticated potato baking process and flavouring technique which results in an end product made from real potatoes which has 3% fat. Although the resulting product included only 3% fat, it was comparatively tasteless when compared with other potato chips and has all but disappeared from the fast food market.

Furthermore, U.S. Pat. No. 5,952,026, U.S. Pat. No. 5,470,600, U.S. Pat. No. 5,194,277 and U.S. Pat. No. 5,858,431 teach the production of a low fat potato product by cooking fresh potato using cooking methods such as microwaving and baking, that do not include the use of fat but which do not have the same taste and mouth feel as products that have been exposed to fat during the cooking process.

There is therefore a need for a novel low fat potato based ready-to-eat product that has a lower fat content and taste acceptable to consumers. Furthermore there is a need for a novel lower fat potato based ready-to-eat product that imparts fewer constraints on potato producers.

### SUMMARY OF THE INVENTION

The novelty of the present invention resides in the frying of dehydrated whole potato product to produce a novel ready to eat product.

The present invention therefore provides a process for production of ready to eat potato product having less than 20% fat, the process including the step of frying dehydrated whole potato pieces having 6.0 to 8.5% moisture to expand starch in the potato pieces. Optionally other potato material may also be expanded.

The product of the present invention may also be characterised in that certain types of protein are removed as a result of the frying process. For example, proteins of greater than about 50 kDa may be absent from the ready-to-eat product of the present invention as compared with ready to eat potato products of the prior art.

Where used herein the reference to % fat is the percentage of fat by weight of product.

The ready-to-eat potato product of the process has a unique crisp crunchy texture, a golden colour and is different in taste to a fully fried potato chip of the prior art, which typically has a fat content of about 25 to 38%. By contrast the present invention provides a product with a fat content (including monounsaturated and polyunsaturated fats) of less than 20%, more typically less than 15% and more preferably between 5 and 13%, the fat content depending principally on the technique used for the frying step.

The term “fat” where used herein it refers to the saturated esters of glycerol and fatty acids and their associated organic groups. Fresh potatoes have no fat content, so the only fat in the product of the present invention is added during processing.

### Dehydrated Potato Pieces

Where used herein, reference to the term “dehydrated whole potato pieces” refers to portions that have been cut from a whole potato. By contrast, this does not include for example, pieces of reconstituted potato wherein cell structures have been destroyed; reconstituted potato often comprises dehydrated potato that has been reduced to powder, mixed with water and formed into shapes such as pellets or disks. Often reconstituted potato powder is combined with other powders such as besan flour (to make pappadums), corn meal (to make Pringles chips) or prawn meal (to make prawn crackers).

The dehydrated potato product used in the process of the present invention includes less than 8.5% moisture, in accordance of the US Department of Agriculture, Commercial Item Description A-A-20165C of 16 Jan. 2003 for dehydrated potato. While processes of the prior art (such as that described in U.S. Pat. No. 3,681,084) have used dehydrated potato product, it has always been thought that it was necessary to raise the moisture content of the dehydrated product to as high as 13 or 14% prior to cooking to produce a palatable potato snack product.

As mentioned above, blanching initiates the gelatinization process in each potato piece and is the combination of applying heat in the presence of moisture that causes gelatinization. Subsequent frying according to the method of the present invention will expand the starch. Typically the dehydrated potato piece will expand by 0.5 to 5 times its original volume, more preferably 0.5 to 3 times its original volume as a result of frying according to the method of the present invention. The thinner the dehydrated potato piece, the greater the expansion.

The person skilled in the art will understand the term dehydrated potato pieces to include any convenient shape including cubes, slices, triangles, wedges, balls, rods of various cross-sectional shapes or strips of potato, but excludes powdered or flaked potato. The fresh cut potato pieces typically have a volume between 125 mm³ and 30 mm³ before dehydration. Alternatively the fresh cut pieces may be strips, typically 10 to 30 mm in length and between 9 and 25 mm³ in cross section. When the fresh cut potato pieces are slices, preferably they are 1 to 3 mm in thickness.

The flexibility of this process to use pieces of potato of various sizes and conformations lends itself to the use of chopped up off-cuts of other potato processes. For example, dehydrated off-cuts from oven chip production could be used in the process of the present invention. Furthermore the process is not limited to potatoes complying with specified sizes or shapes. Potatoes of any size or shape could be used, therefore providing a use for the out of specification potatoes that farmers cannot sell for processing, and in the past fed to cattle or dumped.

### Preferred Potatoes

Preferably the process of the present invention uses dehydrated pieces of potatoes having low moisture and sugar content, but high starch. The dehydrated pieces are typically from the accepted crisping varieties. Preferably the potatoes used in the process are chosen from the group comprising Russet Burbank, Russet Arcadia, Norgold Russet, Goldrush, Norkotah, Long White, Atlantic and Idaho or combinations thereof. More preferably the potato used is the Atlantic potato.

Atlantic potatoes are exclusively sold for processing—their composition makes them unsuitable for sale as fresh produce. In order to grow them within the size limits and shapes specified by processing companies, farmers can only harvest a usable yield of 18 ton/acre. However, the current process provides a use for out of specification potatoes, the will give farmers the option of increasing the harvest towards the theoretical maximum usable rate of 30 ton/acre, and still being able to sell the entire crop.

### Typical Processes

Typically the dehydrated potato pieces are flash fried in a conventional pellet fryer in oil at a temperature of greater than 190° C., typically between 190 and 210° C. to expand the starch in the potato, typically for a period of less than 60 seconds, more preferably from 20 to 50 seconds. The appropriate frying time will depend on the shape of the dehydrated potato pieces. Typically the dehydrated potato pieces will expand to 1.5 to 5 times, more preferably 0.5 to 3 times their dehydrated volume and have a moisture content of 1 to 3%.

Alternatively the dehydrated potato pieces may be cooked in a spray fryer, the dehydrated potato pieces being transported on a conveyor belt into a heated frying chamber where it is sprayed with hot oil, typically for 20 to 50 seconds. The dehydrated potato product typically expands to between 2 to 5 times its dehydrated volume and reaches a finished moisture level of 1 to 3%.

The oil may be any suitable commercially used frying oil, fat or shortening. Preferably the oil used is chosen from the group including safflower oil, sunflower oil, soybean oil, cottonseed oil, canola oil, corn oil, peanut oil, sesame oil, olive oil, lard, vegetable shortening and combinations thereof.

In an alternative process, the potato pieces are subjected to high pressure between 1 and 5 ton/cm² at 230 to 250° C. for 30 to 120 seconds. When the dehydrated potato pieces are in the form of small cubes, this process produces a rough textured product consisting of small cubes fused together. The rough textured product would typically be formed as a disk or “cake”.

### Typical Products

The ready-to-eat potato products of the prior art can include potato chips, crunchy potato pieces, potato rods and potato croutons suitable for use in salads and soups. The ready-to-eat potato product may be seasoned with salt or flavouring, or left unseasoned. Salting or seasoning may occur immediately after frying or the product may be stored in appropriate conditions for salting or seasoning at a later date. The final seasoned or unseasoned product may be packaged for distribution or sale. Typically the ready-to-eat product may be placed in small packages for retail sale or for insertion into pre-packaged salads (in the case of crouton product). The ready-to-eat packaged product may be packed into bulk containers for sale or distribution to food manufacturers such as companies that manufacture package soups. Alternatively they may be packed into containers for transport to point of sale locations.

Unlike ready to eat potato products of the prior art, the product of the present invention remains fresh for a comparatively longer period of time. For example, potato chips such as Pringles, once removed from their packaging and exposed to the air will become soft and lose their crunch within 2 or 3 hours. This is principally due to absorption of moisture from the atmosphere. By contrast, the product of the present invention will retain its crunch and not absorb significant atmospheric moisture for between 1 and 3 days.

### EXAMPLES

Various embodiments/aspects of the invention will now be described with reference to the following non-limiting examples and the figures in which:

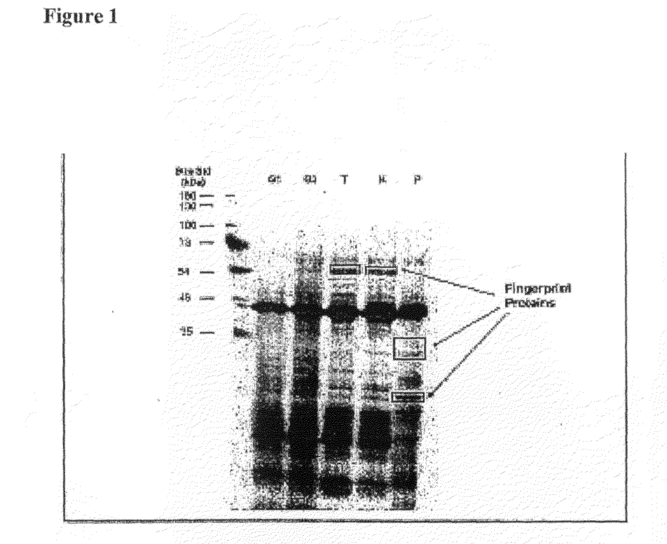

FIG. 1 is a photograph of SDS-polyacrylamide gel electrophoresis plate comparing results from two ready to eat potato products made according to two embodiments of the process of the present invention (G1 and G2) as compared with ready to eat products of the prior art, namely Kettle chips (K), Thins chips (T) and Pringles chips (P); and

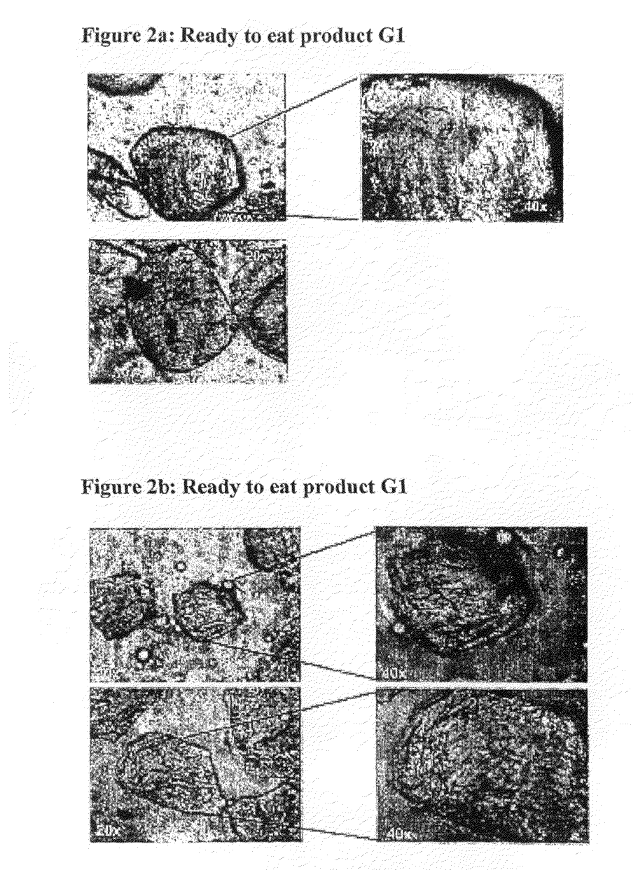

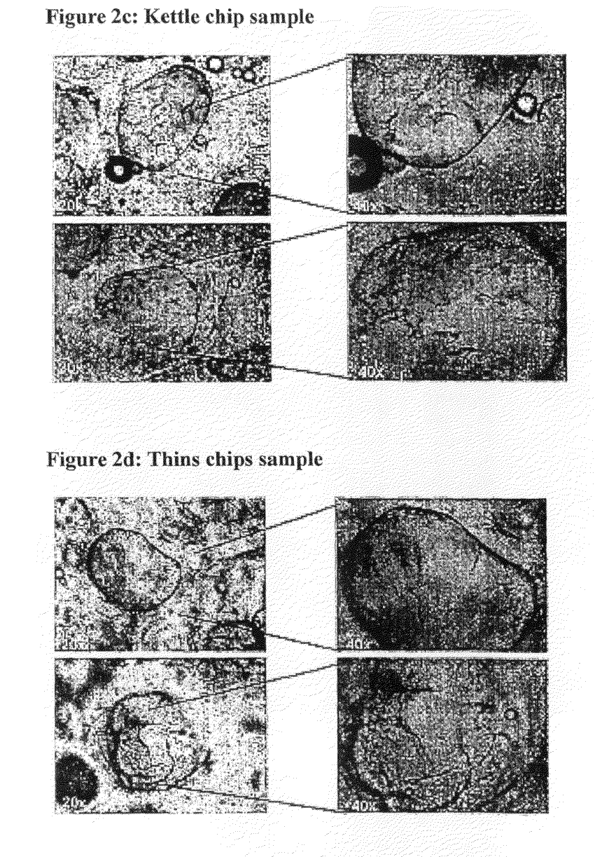

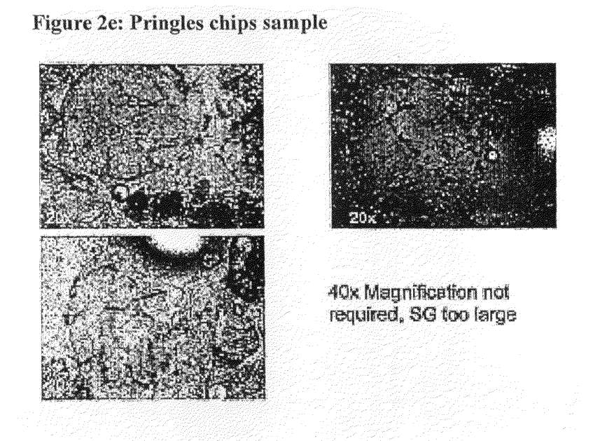

FIG. 2 is a series of photographs of aqueous suspensions of,
ready to eat product G1 (FIG. 2a),
ready to eat product G2 (FIG. 2b),
Kettle chips (FIG. 2c),
Thins chips (FIG. 2d), and
Pringles chips (FIG. 2e).

### Example 1

1 kilogram of diced dehydrated Atlantic potatoes were obtained from Amish Foods, Inc of Pennsylvania, USA. The diced dehydrated pieces measured on average 5 mm×5 mm×5 mm. The dehydrated potato pieces were dropped into stirred sunflower oil at 178° C. for 50 seconds, then removed using a wire spoon.

The resulting ready-to-eat potato product had 15% fat, and retained its crunch, without any discernable softening for 3 days.

### Example 2

1 kilogram of Russet Burbank potatoes were cut into slices of 1 mm thickness and diameter of 20 mm to 40 mm. The potato slices where then left in a commercial dehydrator for 48 hours to reduce their moisture content to 8%. The dehydrated potato pieces were dropped into stirred sunflower oil at 178° C. for 50 seconds, then removed using a wire spoon. The resulting ready-to-eat potato product had 15% fat, and retained its crunch, without any discernable softening for 3 days.

### Example 3

100 grams of diced dehydrated Atlantic potatoes were obtained from Amish Foods, Inc of Pennsylvania, USA. The potato pieces were placed inside a stainless steel cylinder and subjected high pressure from a stainless steel ram at 250° C. for 0.2 seconds. When the pressure was released, the dehydrated potato pieces were found to have fused together to form a disk, having a rough texture.

### Example 4

### Protein Profile Measurement

1 kilogram of Atlantic potatoes was divided into two groups (designated G1 and G2). Group G1 was diced into 12 mm³ cubes which were blanched by application of hot water for 3.5 minutes. Group G2 was cut into slices of 1 mm thickness and blanched in hot water for 90 seconds.

The unique ready to eat products formed from G1 and G2 were then extracted using 8M urea to strip out the starch. The G1 and G2 extracts were separately subjected to SDS-polyacrylamide gel electrophoresis to visualize the proteins separated by size.

The same extraction process and gel electrophoresis was carried out on three potato chip products of the prior art, namely Thins potato chips (T), Kettle chips (K) and Pringles chips (P). The results of the gel electrophoresis is depicted in FIG. 1. It is readily apparent that the unique ready to eat products of the present invention can be distinguished from potato chips of the prior art by a different protein profile. In particular the products G1 and G2 do not include fingerprint proteins of 54 kDa, unlike the Thins or Kettle chips.

### Example 5

### Microscopic Analysis

2 g samples of the ready-to-eat potato products G1 and G2 of Example 4 were ground using an electric coffee grinder (10× 1 sec bursts followed by 10 sec of continuous grinding). 100 mg of each of the ground chip samples G1 and G2 were suspended in 1 ml water, vortexed for 5 sec and 100 μl of the suspension placed on a microscope slide under a coverslip. The starch granules of G1 and G2 were then identified on the slide and photographed under 20× and 40× magnification.

2 g samples of each of Thins potato chips (T), Kettle chips (K) and Pringles chips (P) were also suspended in the same manner and photographed under the same magnification. The photographs are shown in FIG. 2a (ready to eat product G1), FIG. 2b (ready to eat product G2), FIG. 2c (Kettle chips), FIG. 2d (Thins chips) and FIG. 2e (Pringles chips).

The photographs of FIGS. 2a to 2e illustrate how the ready to eat product of the present invention can be readily differentiated and identified from the potato chip products of the prior art. In particular, the starch granules in G1 and G2 were translucent with a shiny, 3-dimensional looking surface (similar to a piece of quartz) and they clearly display what look like filaments or wrinkles that constitute the structure of the starch granules. By contrast the starch granules of the Kettle chips, Thins chips and Pringles chips were more transparent with only a few filaments or wrinkles. The starch granules of G1 and G1 also appear to be more angular as compared with the rounded granules of the prior art products.

The word ‘comprising’ and forms of the word ‘comprising’ as used in this description and in the claims does not limit the invention claimed to exclude any variants or additions.

Modifications and improvements to the invention will be readily apparent to those skilled in the art. Such modifications and improvements are intended to be within the scope of this invention.

1. A ready to eat potato product having less than 20% fat prepared by frying dehydrated whole potato pieces having between 6.0 and 8.5% moisture to expand the starch in the potato pieces.

2. The ready to eat potato product of claim 1 characterised in that it comprises proteins of no less than 50 kDa.

3. The ready to eat potato product of claim 1 having less than 15% fat.

4. The ready to eat potato product of claim 1 wherein the pieces of ready to eat potato product are from 1.5 to 5 times the volume of the dehydrated whole potato pieces prior to frying.

5. A process for production of ready to eat potato product having less than 20% fat, the process including the step of frying dehydrated whole potato pieces having between 6.0 and 8.5% moisture to expand the starch.

6. A process for production of ready to eat potato product according to claim 5 wherein the frying step comprises frying at a temperature of between 160 and 210° C. for a period of 20 to 90 seconds.

7. A process for production of ready to eat potato product according to claim 5 wherein the frying step comprises frying at a temperature of at least 190° C. for a period of 20 to 50 seconds.

8. The process of claim 5 wherein the ready to eat potato product comprises proteins of no less than 50 kDa.

9. The process of claim 5 wherein the ready to eat potato product has less than 15% fat.

10. The process of claim 5 wherein the pieces of ready to eat potato product are from 1.5 to 5 times their volume prior to frying.

11. The process of claim 10 wherein the pieces of ready to eat potato product are from 1.5 to 3 times their volume prior to frying.
